(19) United States
(12) Patent Application Publication
(10) Pub. No.: US 2011/0166946 A1
(43) Pub. Date: Jul. 7, 2011

(54) METHOD OF PROMOTING AND SELLING COFFEE

(75) Inventors: Mathieu Renouf, La Tour-de-Peilz (CH); Philippe Alexandre Guy, Lausanne (CH); Cynthia Colette Olga Marmet, Yverdon-les-Bains (CH); Heike Steiling, Montreux (CH); Christophe Cavin, Montreux (CH); Gary Williamson, Harrogate (GB)

(73) Assignee: NESTEC S.A., Vevey (CH)

(21) Appl. No.: 13/062,989

(22) PCT Filed: Sep. 8, 2009
(86) PCT No.: PCT/EP2009/061637

§ 371 Date: Mar. 9, 2011

Related U.S. Application Data
(60) Provisional application No. 61/096,129, filed on Sep. 11, 2008.

(51) Int. Cl. G06Q 30/00; G06Q 90/00

(52) U.S. Cl. 705/14.73; 705/500

(57) ABSTRACT

The disclosure provides coffee products and methods for selling, promoting, and advertising coffee products as well as generating revenue from same.

### BACKGROUND

The present disclosure relates generally to nutritional products and methods of promoting and selling same. More specifically, the present invention relates to coffee containing products and methods of marketing and selling same.

Antioxidants are molecules that are capable of either slowing or preventing the oxidation of other molecules. In the body, oxidation reactions can produce free radicals that can damage cells. Antioxidants work by removing the free radical intermediates and inhibiting other oxidation reactions.

Although oxidation reactions are crucial for life, they can also be damaging. Accordingly, in animals, there are complex systems that provide multiple types of antioxidants such as glutathione, vitamin C, and vitamin E. These antioxidants work to reduce oxidative stress that can damage or kill cells.

Much research and investigation has focused on antioxidants and oxidative stress. Whether or not oxidative stress is the cause or consequence of disease is not known. However, studies have suggested that antioxidants and antioxidant supplements have health benefits in reducing oxidative stress and the damage caused thereby.

Antioxidants are found in a variety of foods and drinks. Such foods include fruits and vegetables and drinks, including tea, coffee, and red wine. Recent attention has focused on green tea as containing high levels of antioxidants. Heretofore, the inventors believe, the belief was that green tea provides more antioxidants to a consumer than a similar quantity of coffee.

### SUMMARY

The disclosure provides coffee products and methods for selling, promoting, and advertising coffee products as well as generating revenue from same.

In an embodiment, the disclosure provides a method for selling a coffee product comprising the steps of advertising that the coffee product provides to a consumer more bioavailable antioxidants than green tea based on the ingestion of the same quantities of green tea and coffee.

The advertising can be made by a method selected from the group of media consisting of: in print; on television; on the radio; and on the internet. The advertising can be on a label of a container housing the product. The method can include advertising: that milk can be added to the coffee product; and/or the benefits of antioxidants to the consumer.

In another embodiment of the disclosure, a method for promoting the benefits of a coffee product is provided comprising the step of stating that the coffee in the coffee product provides more bioavailable polyphenols to a consumer when ingested than a similar quantity of green tea. The method can include highlighting the benefits of polyphenols to the consumer.

Still further, the disclosure provides a method for promoting a consumable product comprising the steps of: noting that the consumable product contains coffee; and stating that coffee provides a consumer of the consumable product more bioavailable antioxidants than a similar quantity of green tea. The consumable product can be selected from the group consisting of: a drink; a chewable food product; pet food; and a nutritional supplement.

The method can comprise the step of making available to the consumer test data that includes a comparison of the bioavailabilities to a consumer of the antioxidants in coffee to green tea.

Moreover, the disclosure provides a package comprising a coffee containing product and a label that comprises a statement that the coffee provides more bioavailable antioxidants to a consumer than a similar quantity of green tea. The coffee product can be selected from the group consisting of: a drink; a food; a pet food; and a nutritional supplement. The coffee containing product is designed to provide a hot beverage. The package can comprise a plurality of single serving sizes.

And in an embodiment, the disclosure provides an advertising campaign based on utilizing data demonstrating that coffee provides a consumer with more bioavailable antioxidants than green tea per consumption of similar quantities.

The data can be based on: plasma pharmacokinetics; and/or bioavailability of polyphenols.

The campaign can promote a product that provides a hot coffee beverage.

The campaign can use at least one media selected from the group consisting of: television; internet; print; and radio.

An advantage of the present disclosure is that it provides methods for selling coffee products.

Another advantage of the present disclosure is that it provides methods for marketing coffee products.

A further advantage of the present disclosure is that it provides ad campaigns designed for promoting coffee products.

Still another advantage of the present disclosure is that it provides a coffee product.

Moreover, an advantage of the present invention is that it provides a method for increasing revenues from the sale of coffee products.

Still further, an advantage of the present invention is that it provides improved methods for generating revenue.

Additional features and advantages are described herein, and will be apparent from the following Detailed Description.

### DETAILED DESCRIPTION

The present disclosure provides coffee products, methods of marketing coffee products, ad campaigns for promoting coffee products, methods of generating revenue from coffee products and the like. In part, the disclosure is based on the discovery that coffee provides more bioavailable antioxidants to a consumer than green tea. This increased level is based on the consumption of similar quantities of each product.

By leveraging the test data that has been generated, coffee can be promoted for its health benefits and, moreover, the increased level of bioavailable antioxidants in coffee as compared to green tea. Heretofore, it is the understanding of the inventors, that the belief was that green tea provided more antioxidants to a consumer than coffee based on the consumption of same quantities of product. The inventors have discovered that this is not correct. Accordingly, a variety of methods of promoting and marketing coffee as well as coffee products and ad campaigns based on same can be provided.

In an embodiment, the present disclosure provides a method of selling coffee products comprising the steps of advertising the fact that coffee provides the consumer more bioavailable antioxidants than green tea based on the ingestion of the same quantities of green tea and coffee. By the statement “ingestion of the same quantities” what is meant is that approximately the same weight and/or fluid ounces of product is utilized. Accordingly, for example, if a comparison of a dried green tea versus a dried coffee product is being made, both products would have substantially the same weight. Likewise, if the comparison is being made based on the volume of liquid of the product, similar units, e.g., ounces of the product would be compared. Still further, if the products being compared only include coffee or tea as one of their components, only the actual weight and/or volume of the coffee and tea would be relevant.

A variety of advertising media can be utilized including, by way of example and not limitation, print, internet, television, radio, movies, and labeling. Print, of course, would include newspapers, magazines, billboards, and the like. Television includes both local television, as well as satellite television and cable television. The use of television and movies can include advertisement during commercial breaks and/or product placement. As used herein, “label” refers to the label on the package containing the coffee product, a label that may be inside the package, the label on a container comprising a plurality of packaged coffee products, and/or the label on the boxes or containers including a plurality of containers. The label can include text and/or pictorial representations.

As noted above, the advertising, promotion, or ad campaign can be with respect to a coffee product. As used herein, “coffee product(s)” include not only hot beverages such as coffee, espresso, cappuccino, and the like, but foods, nutritional supplements, and clinical nutrition including coffee products. Further, coffee products can include products for other mammals, besides humans, including pet foods. In order to be characterized as a coffee product, a product includes some portion thereof as coffee or is based on coffee.

As used herein, the term “ad campaign” refers to a program, plan, strategy, scheme, agenda, or the like designed to sell or promote a product or service. The ad campaign can be undertaken by an advertising agency, individual, partnership, store, company, and/or other entity that ultimately is desirous of selling a product or service. The ad campaign may be reduced to tangible form such as in writing or it may be conveyed orally.

As used herein, the term “comparison” refers to either a direct comparison of coffee to green tea or an indirect comparison. For example, direct statements can be made on the label or other advertising comparing the bioavailability of antioxidants in coffee to green tea. On the other hand, explicit comparison is not necessary, for example, indirect comparisons be made, that can include, for example, a listing indicating that coffee has a higher rating as compared to green tea, statements by third parties (such as alleged experts), or pictorial representations. What is required is that the consumer is led to believe that coffee provides a greater level of antioxidants than green tea.

As used herein “a coffee product” may be any product based on coffee beans or coffee cherries and intended for oral consumption by a human or animal. A coffee product may e.g. be ground coffee beans, e,g, roast and ground coffee beans; soluble coffee; coffee bean extract; or a ready to drink coffee beverage. A coffee product may be produced from green coffee beans, roasted coffee beans, or a combination of green and roasted coffee beans, and may comprise additional ingredients such as e.g. a creamer, milk, milk protein, milk fat, vegetable fat, vegetable protein, sugar, artificial sweetener, stabilizer, and/or other ingredients conventionally used as in coffee products.

Pursuant to the present disclosure, a consumer can be provided with or have access to information demonstrating the better bioavailability of the antioxidants in coffee as compared to green tea. This data can either be provided with the coffee product itself, at a location that sells or dispenses the coffee product, from the company that sells or dispenses the coffee product, over the internet, or through a variety of other means. For example, the label of the coffee product or other packaging can indicate a website from which the information is available. This information can, for example, demonstrate the bioavailability of antioxidants in coffee and green tea as measured by plasma pharmacokinetics. This, therefore, can allow the consumer access to the information to verify the statements that are being made.

Of course, those skilled in the art, including arts such as marketing and advertising, can envision a wide variety of ways to implement and promote the fact that coffee provides more bioavailable antioxidants than green tea. The present disclosure is not intended to be limited to any specific manner of promoting or leveraging this information.

In addition, the present disclosure also provides an understanding of the potential effect, if any, of whole milk or creamer on the bioavailability of coffee antioxidants. This information can also be used by the concepts of the present disclosure.

By way of background, coffee contains phenolic compounds called hydroxycinnamates, which consist principally of chlorogenic acids, a family of trans-cinnamic acids conjugated with quinic acid. The main chlorogenic acid in coffee is 5-caffeoylquinic acid (5-CQA).

The polyphenols in coffee are chlorogenic acids: CQA, feruloylquinic acid (FQA) and dicaffeoylquinic acid (di-CQA). Their content may vary depending on the type of coffee. Structures of chlorogenic acids found in coffee are as follows:

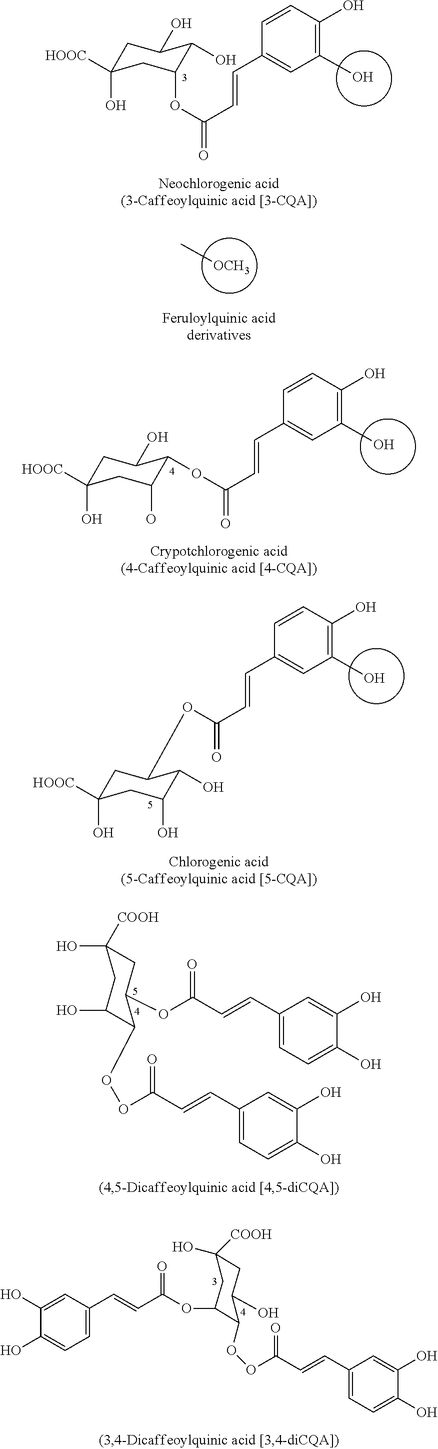

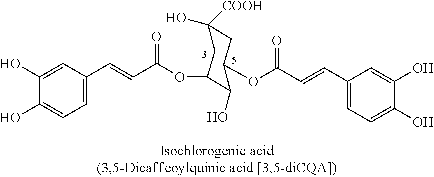

Bioactive compounds that have been identified in coffee include: hydroxycinnamate conjugates such as the caffeoylquinic acids, the feruloylquinic acids, the •-coumaroyiquinic acids and the dicaffeoylquinic acids; free hydroxycinnamates: caffeic acid, ferulic acid and •-coumaric acid; alkaloids: caffeine and smaller amounts of its precursor, theobromine; the diterpenes cafestol and kahweol; proanthocyanidins in coffee pulp; Maillard Reaction Products (MRP's); Melanoidins in roast coffees; and Quinolactones (QL) in roasted coffee, with 3-QL and 4-QL being the most abundant. These compounds have various in vitro or ex vivo anti-carcinogenic and antioxidant properties.

Upon ingestion, a small part of 5CQA is absorbed in the stomach and in the small intestine. However, the presence of quinic acid on caffeic acid may limit the intestinal absorption of 5CQA as such. Esterases from intestinal microbiota can metabolize 5CQA into caffeic acid.

Studies have shown that, after ingestion of chlorogenic acid, caffeic acid was detected in plasma, suggesting that chlorogenic acid can be cleaved into caffeic acid. After intragastric infusion of 5-CQA, only trace of caffeic acid was detected at the end of the treatment. Moreover, no caffeic acid was detected in the plasma of the gastric vein at the end of the treatment. This shows that gastric conditions and gastric cells should not responsible for the hydrolysis of CQA. By contrast, isoferulic acid, a methylated form of caffeic acid (CA), was identified in rat plasma after intestinal perfusion of 5-CQA. Regarding these data, it seems that enterocytes could be responsible for the hydrolysis of 5-CQA into caffeic acid. However, this process seems to be limited as only 0.12 μM of isoferulic acid was detected after 50 μM chlorogenic acid perfusion. Interestingly, caffeic acid was recovered in the caecum lumen of rats supplemented with 5CQA, suggesting that CQA can be cleaved into caffeic acid in the caecum via microbial transformation. Previously, esterase activity has been observed in human fecal extracts, but not in human small intestine, liver, and plasma extracts. There is a possibility that the hydrolysis of chlorogenic acid occurs by the action of esterases in colonic microflora and that the resulting caffeic acid can be absorbed in part.

In preclinical models, no 5CQA or traces of this compound are present in plasma after ingestion. The main plasma metabolites are conjugated forms of CA that rapidly appeared (30 min) after ingestion in this biological fluid. In humans, the presence of CQAs is still controversial. After a rapid absorption in the small intestine, CQAs are mainly detected in plasma as conjugated forms.

Usually, polyphenols are metabolized by conjugative enzymes in several organs (intestine, liver) after absorption. This means that their hydroxyl group can be linked to glucuronic acids and/or sulfates and/or methyl moieties and these conjugated forms are then present in biological fluids.

With respect to green tea, green tea polyphenols are catechins. While some of them are widely distributed in fruits and vegetables, epigallocatechin gallate is only found in tea. Tea is an infusion of the leaves of the Camellia sinensis plant and is the most widely consumed beverage in the world after water. Some biologically active chemicals in tea include flavonoids, caffeine, and fluoride.

Processing and brewing of tea is the first step in generating a complex blend of chemically diverse flavonoid compounds. The most abundant are the flavan-3-ols, and among them the catechins, including: (−)-Epicatechin (EC), (−)-Epicatechin 3-gallate (ECG), (−)-Epigallocatechin (EGC), (−)-Epigallocatechin 3-gallate (EGCg), and (+)-Catechin.

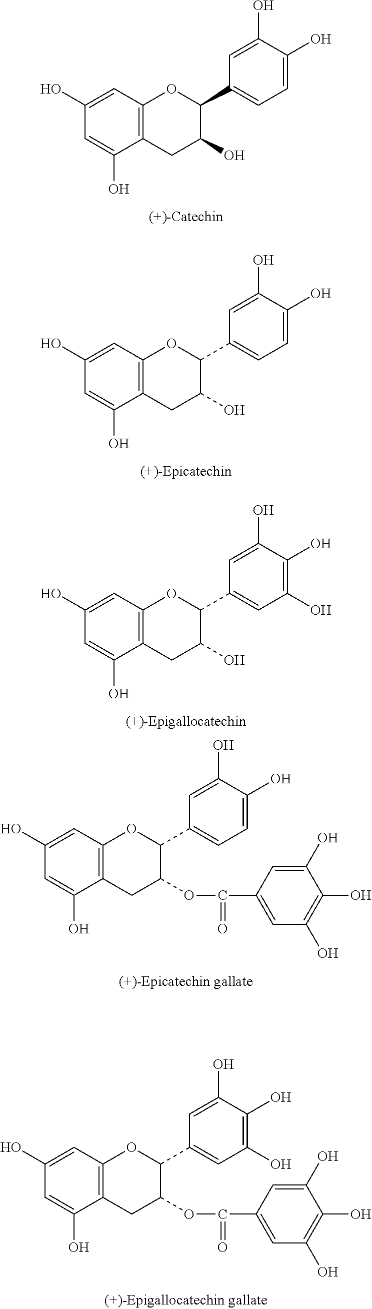

Chemical Structure of the Five Prominent Tea Catechins

While EC is found in many fruits and vegetables, EGC and ECg are more specific: EGC is present also in fava beans and ECg in grape. EGCg is found only in tea. All teas contain catechins, but white and green teas have the highest concentrations. EGCg represents more than half the total catechin content of green tea and only ˜30% of catechins in black tea.

Fermentation of tea is an enzymatically catalyzed, oxidative process (Polyphenol Oxidase) in which catechins are oxidized to more complex polymers such as theaflavins and thearubigins).

In humans, green tea catechins (EGC, EGCg and EC) and their conjugated forms are present in plasma after ingestion. They appeared in blood within 30 min after ingestion and disappear very quickly to reach baseline level within 12 h after ingestion.

Because of its worldwide use, green tea has been investigated for the potential antioxidant effect of its bioactive compounds. Besides antioxidant activity, green tea polyphenols have been investigated for their potential antimutagenic, antidiabetic, antibacterial, anti-inflammatory and hypocholesterolemic properties.

Very few studies have focused on understanding how proteins, especially from milk, may impact bioavailability and bioefficacy of chlorogenic acids. No consensus on the potential effect of milk has been reached yet.

A study found that 5-CQA binds to bovine serum albumin (BSA) in vitro. It was also observed that a negative relationship between temperature and 5-CQA binding while pH produced a positive relationship with 5-CQA binding. Another study found a 40% binding of CQA to casein, binding that persist to 17% at the end of the digestive process. How binding of CQA affects bioavailability of coffee chlorogenic acids needs to be further investigated. Another study focusing on tea did not show any difference in human bioavailability of black tea compared to black tea+˜15% skimmed milk as measured in the plasma area under the curve, maximum concentration, time to reach C max and elimination rate. On the other hand, a study showed that adding 20% whole milk to black tea produced a significant decrease in catechins plasma area under the curve and Cmax. However, differences in the study designs make it difficult to formulate any conclusive evidence about the role of milk in modulating bioavailability of tea catechins.

The same pattern was observed in looking at bioefficacy of tea compared to tea and milk. On one hand, a study found that adding milk does not decrease the antioxidative capability of bioactive compounds found in coffee and tea, as measured by LDL lag time of oxidation. On the other hand, a study showed that adding 10% skimmed milk to black tea inhibit the positive effect that tea alone produced on the cardiovascular system of postmenopausal women, as measured by flow mediated dilation of the forearm brachial artery. In most of these studies, the impact of milk on BV of polyphenols has been shown by indirect measurement.

By way of example and not limitation, examples and experiments demonstrating aspects of the present disclosure will now be given.

A primary objective was to investigate plasma bioavailability of coffee chlorogenic acids and green tea catechins.

To evaluate this primary objective, the following outcome was measured:

Measure AUC over 12 h after ingestion of phenolic acids derived from chlorogenic acids (caffeic acid (CA), ferulic acid (FA), dihydroferulic acid (DHFA), dihydrocaffeic acid (DHCA), isoferulic acid (iFA)) in the blood (breakdown of chlorogenic acids after full enzymatic deconjugation) and that of tea catechins (epicatechin (EC), (−)-epicatechin-3-gallate (ECG), (−)-epigallocatechin-3-gallate (EGCG), (−)-epigallocatechin (EGC)) in the blood (after full enzymatic deconjugation).

The secondary objective of the trial was to investigate the difference in plasma and urinary bioavailability of chlorogenic acid metabolites in the different coffee preparations (coffee vs. coffee 3 in 1 and coffee vs. coffee+10% whole milk).

To evaluate this secondary objective, the following outcome was measured:

AUC (12 h), Cₘₐₓ, Tₘₐₓ of chlorogenic acids or metabolites in plasma from coffee vs. coffee 3 in 1.

AUC (12 h), Cₘₐₓ, Tₘₐₓ of chlorogenic acids or metabolites in plasma from coffee vs. coffee+10% whole milk

Urinary excretion over 36 h as derived from the cumulative urine curve (after full enzymatic deconjugation) for coffee phenolic acids derived from chlorogenic acids from coffee compared to coffee 3 in 1 and from coffee compared to coffee+10% whole milk.

Another secondary objective was to evaluate the urinary bioavailability of coffee chlorogenic acids (coffee) and green tea catechins.

To evaluate this secondary objective, the following outcome was measured:

Urinary excretion over 36 h as derived from the cumulative urine curve (after full enzymatic deconjugation) for coffee phenolic acids derived from chlorogenic acids and tea catechins.

Trial Design

The proposed study was a randomized post-prandial test in 4-treatment X 4-period cross-over design and a wash-out period of 1 week between the different treatments.

At −1 week prior to the first treatment, the subjects were weighed, their height measured and BMI calculated. The subjects were randomized into a possible sequence of treatments.

For each period 1, 2, 3 and 4:

At −24 hours until the end of the present sampling period the ingestion of coffee, tea, cola, alcohol, whole grain cereal (white bread allowed) or any medication was prohibited. Only water was allowed during the night and in the morning before the treatment.

Day 0: The day of treatment:

7.30: the subjects arrived fasting at the Metabolic Unit with the filled pre-intervention diet recording sheets of the last 2 days. They received a form to report any deviations from the study plan or non-beneficial effects of the treatment.

7.30-8.00: baseline blood and urine sampling.

Subjects received at random one of the four treatments along with a standard breakfast (white bread and honey). Subjects ate the same breakfast for all 4 treatment periods.

At t=0.5, 1, 1.5, 2, 3, 4, 5, 6, 8, 10, 11 and 12 h after treatment: blood sampling.

At t=0-4, 4-8, 8-24 h and 24-36 h after treatment: urine collection. A flask for collection between 8 and 24 h (next morning) and 24-36 h was provided.

A standard lunch was provided at the metabolic unit.

The subjects were encouraged to drink as much as they want. Water was available the entire day.

Day 1:

7.30-8.00: 24 h fasting blood sampling and collection of 8-24 h urine sample.

Early evening: collection of 24-36 h urine sample

Subjects: description, inclusion and exclusion criteria

After completing a medical questionnaire and having an initial interview with the investigator, 12 subjects were recruited. If any subjects dropped out, they should have been replaced so that a minimum of 12 subjects completed the study.

All subjects had to comply with all the following inclusion criteria: 18-45 years; healthy as determined by the medical questionnaire; average coffee consumption of 1-5 cups per day; normal weight: BMI 18-25; non-smoker; and having obtained his/her informed consent.

Subjects representing one or more of the following criteria were excluded from participation in the study: smokers; intestinal or metabolic diseases/disorders such as diabetic, renal, hepatic, hypertension, pancreatic or ulcer, food allergy; volunteers with a previous occupational exposure to green coffee beans; have had major gastrointestinal surgery; difficulty to swallow; have a regular consumption of medication; have a high alcohol consumption (more than 4 drinks/day); patient who cannot be expected to comply with treatment; allergy to milk protein (casein); have given blood within the last 3 weeks; or currently participating or having participated in another clinical trial during the last 3 weeks prior to the beginning of this study.

Treatment I: coffee: 4 g instant coffee powder produced from a blend of green and roasted coffee beans in 400 ml distilled water.

Treatment II: coffee 3 in 1: 30.5 g instant powder containing 4 g instant coffee produced from a blend of green and roasted coffee beans dissolved in 400 ml water.

Treatment III: coffee+10% pasteurized whole milk: 4 g instant coffee powder produced from a blend of green and roasted coffee beans in 360 ml distilled water+40 ml pasteurized whole milk.

Treatment IV: Green tea: 1.25% infusion in 400 ml water.

Instant coffees were reconstituted with water prior to consumption. All four treatments were each ingested at one occasion with a 1 week washout in between. Coffee had a total chlorogenic acid content of 335 mg (900·mol). Green tea from Twinnings was used and 1.25% infusion in 400 mL water provided 298 mg (800·mol) total catechins. Dosage of the beverages were done according to the recommendations of the Australian market.

Treatment Administration

From 24 hours before the first treatment no foods containing chlorogenic acids and only food with low polyphenol content were ingested. The subjects received a single dose of the 4 treatments in a randomized order with a one week washout in between.

The study subjects received during breakfast an oral dose of instant coffee with or without milk or green tea per treatment in a volume of 400 ml, ingested on 4 separate days with a washout time of one week in between.

All beverage treatment were used in a human post-prandial test in a crossover design. After the ingestion of two 200 ml cup of beverage treatment, plasma was collected over a 24-h period and urine over a 36-h period to investigate the occurrence of coffee chlorogenic acids or tea catechins and their respective metabolites.

The beverages were orally administered to each volunteer. The instant beverages (coffee treatments) or infusion (green tea) were cooled down from 100° C. to reach a temperature of 55-60° C. (˜15 min) and were then be consumed in less than 5 min (Important since first metabolites appear already after one hour in plasma).

Samples obtained from intervention itself were processed immediately. Blood samples were collected in 7 ml EDTA tubes and stored on ice for a maximum of 15 min (preferably less) before centrifugation (3500×g, 10 min, +4° C.). A precise volume (0.5 ml) of supernatant (plasma) was removed with a pipette and transferred to a labeled 3 ml cryotube. Several aliquots of 0.5 ml were made in this way. To each tube containing 0.5 ml plasma, 20•l of storage solution (0.4 M NaH₂PO₄ buffer containing 20% Ascorbic acid and 0.1% EDTA, pH 3.6;) were added. Samples were then sealed and frozen upright at −80° C. If not possible, they were placed on ice immediately until freezing as soon as possible.

Urine samples were collected in acid washed urine collection flasks containing HCl and ascorbic acid (pre-weighed HCl-washed 1 l urine collection flasks containing 10 ml 1M HCl and 2 ml aqueous ascorbic acid at 100 g/l. The flasks were prepared on the same day as collection of the particular sample). During the collection intervals, the flasks were kept at 5° C. At the end of each collection interval, the total volume was measured, and a maximum of 25 ml urine was added to pre-weighed, labeled 50 ml Falcon tubes containing ascorbic acid. The total weight of each sample was monitored and recorded, and pH adjusted to 3-4 with 1M HCl using a pH-meter. The samples were then stored at −80° C.

Not enough is known about the effect of drugs on the absorption of chlorogenic acids to permit the use of any medication during the 12 hours before each treatment and during the sample collection. The remaining part of the time, paracetamol (1000 mg) is allowed.

No foods containing chlorogenic acids from 24 hours before each treatment until the last sample is collected was allowed.

There was no ingestion of coffee, tea, cola, alcohol, whole grain cereal and drugs on the evening before treatment and during the sampling.

Material and Methods

Coffee Chlorogenic Acids

Measurement of phenolic acids in human plasma was by HPLC-MS/MS).

Green Tea Catechins

Measurement of catechins in human plasma was by HPLC with electrochemical detection.

Statistical Analysis

The Intention To Treatment analysis (ITT) was performed on all subjects for safety evaluation only.

Per Protocol evaluation (PP) was defined as all the subjects excluding the following periods: if subjects had ingested prohibited food items or medication 48 h before or during the treatment.

After the prefreezing meeting two major protocol deviations were defined: missing measurements during the first 12 hours of evaluation; and antibiotic therapy during the course of the study.

Statistical Analyses Planned in the Protocol

Global Specifications:

Demographic and baseline characteristics were documented by descriptive statistics.

Values below the LOQ were set to LOQ before calculating the AUC.

All the parameters were skewed to the right and needed a log₁₀ transformation to reach normality. Thus data are described by the geometric mean and the first and third quartiles (Q1 and Q3). The estimations of the treatment effect are presented as the ratio of geometric means and its 95% confidence interval.

All statistical analyses are done with SAS software (version 9.1). The rejection level in statistical tests is equal to 5%. After the sign ±, the standard deviation is given.

Primary Objective:

After consumption of coffee, all 5 measured antioxidants could be evaluated in the plasma (i.e. most values are above the limit of quantification LOQ).

After consumption of green tea, only 3 of the 5 measured antioxidants could be evaluated in the plasma (i.e. EC, EGC and EGCg). For the two others (C and ECg) the initial levels in the beverage were too low to expect measuring something in the plasma. As a consequence, it was agreed that only 3 green tea antioxidants would be further considered (i.e. EC, EGC and EGCg).

The AUC (using nM) was calculated for each antioxidant separately and the comparison was only done on a global level (sum of antioxidants).

The AUC was calculated between 0 and 12 h, although some curves were not complete. Although a 24 h time point was available, it was not possible to extrapolate the curves during the 12-24 h interval. Thus, only data points between 0 and 12 h were considered to calculate AUC. A mixed model with treatment as fixed effect and subject as random effect was used.

Secondary Objectives:

The secondary objective was defined as the comparison of coffee vs. two alternative preparations featuring coffee (i.e. with creamer or milk).

The comparison was performed separately for each antioxidant (i.e. no summation of antioxidants).

Antioxidants “DHCA” and “DHFA” were not considered for calculation of Cₘₐₓ, Tₘₐₓ and AUC₍₀₋₁₂ₕ₎. Indeed, the kinetic profile of several subjects were not exploited at 12 hours, according to the available data it was not possible to define soundly these parameters. Therefore the analysis of coffee antioxidants was done only on three metabolites of the chlorogenic acid (caffeic acid, ferulic acid and isoferulic acid) instead of five.

A mixed model with treatment as fixed effect and subject as random effect was used.

Additional Analysis:

As additional analysis, the primary objective was assessed using the same model as but changing the outcome. Indeed, in this evaluation all the values below the LOQ were replaced by 0.

Beverages

Total CGA in coffee used for this study was 8.8% dry basis, which corresponded to 335 mg or 900 umol of total CGA ingested as a 4 g dose dissolved in 400 mL.

Chlorogenic acid content determined as a percentage dry basis was obtained from PTC Orbe. Determination of CGA was done via HPLC analysis:

| Chlorogenic acids (% dry basis) | |
|---|---|
| 3CQA | 1.02 |
| 4CQA | 1.38 |
| 5CQA | 4.00 |
| 4,5diCQA | 0.54 |
| 3,4iCQA | 0.50 |
| 4FQA | 0.18 |
| 5FQA | 0.75 |
| 3CQA-lactone | not determined |
| 4CQA-lactone | not determined |
| Total (HPLC method) | 8.80 |

Based on this composition, the quantity and molarity of chlorogenic acids in a 4 g dose of soluble coffee was as followed:

| | Coffee | Coffee |
|---|---|---|
| | 4 g solids in | 4 g solids in |
| | 400 mL | 400 mL |
| | mg | Umol |
| CQA | 256 | 722 |
| FQA | 37.2 | 101 |
| di-CQA | 41.6 | 80 |
| TOTAL | 334.8 | 903 |

Catechin Content in Green Tea

A 1.25% infusion corresponding to 2 green tea bags infused for 3 min 400 mL of boiling water showed a total catechin content of 300 mg or 800 umol.

Catechin content in green tea beverage was calculated after infusing for 3 min in boiling water 2 green tea bags (˜5 g green tea in 400 mL water or 1.25% infusion). Determination of catechin content was done by LC-coularray analysis and gave the following results:

| | Twinnings green tea | Twinnings green tea |
|---|---|---|
| | 1.25% infusion in | 1.25% infusion in |
| | 400 mL | 400 mL |
| | mg | Umol |
| catechins | 7.5 | 25 |
| EC | 37.1 | 127 |
| ECG | 38.6 | 80 |
| EGC | 80.8 | 263 |
| EGCG | 133.8 | 292 |
| TOTAL | 297.9 | 800 |

Values above correspond mg in 400 mL of 1.25% infusion Twinnings green tea.

Description of the Treatment Groups:

The PP data set has comparable characteristics to the ITT one. The PP data set is composed of 5 females and 4 males. At baseline, the mean age is 34±7 years (range: 25-46), the mean body weight is 68±10 kg (range: 52-90), length is 170±8 cm (range: 157-180) and BMI is 23.64±2.82 kg/m² (range: 20.31-28.41).

ITT and detailed data per subjects are found in appendix 3.

Plasma Analyses after Coffee Treatments

LC-MSMS Results

Plasma pharmacokinetics after ingestion of coffee, coffee 3 in 1 or coffee+milk

After coffee consumption, 5 major metabolites were detected in plasma, 3 reaching maximum concentration 1-2 h after ingestion (CA, FA, iFA) and 2 reaching Cmax 8-12 h after ingestion (DHCA and DHFA). Thus, both the small intestine and the colon are major sites of metabolism and absorption for coffee CGAs. Baseline levels were reached by 12 h for CA, FA and iFA while many subjects were still showing detectable amounts of DHFA and DHCA by 12 h.

Below are examples of plasma kinetics of CA, FA, iFA, DHFA and DHCA.

The overall comparison of those curves show 2 groups of metabolites. Both groups show biphasic curves with a first peak at ˜1 h after ingestion and second 8-12 h after ingestion. The first group: CA, FA and iFA show a Cmax within the first hour after ingestion. The second group: DHCA and DHFA show the maximum concentration in plasma 8-12 h after ingestion.

Calculation of AUC was done over the first 12 h after ingestion despite the fact that we have a time point at 24 h. Statistically, extrapolating kinetic curves between 12 and 24 h is not feasible in the present case as there are not enough points in the “descent phase” of the kinetic curve. The 24 h time point is only used to assess if plasma concentration of the compounds of interest are back to baseline but is not used in statistical analysis of AUC.

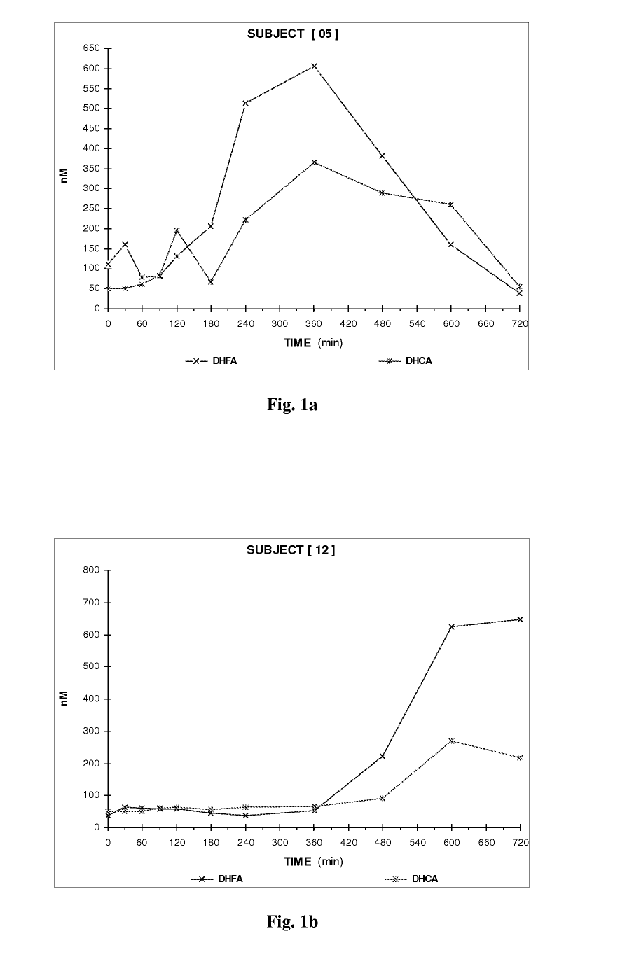

As shown in the following graphs, while some subjects showed levels close to baseline by 12 h for the second group of metabolites (full AUC; see subject 05 in FIG. 1a) other subjects failed to even show a Tmax as maximum plasmatic concentration of DHFA or DHCA was not even reach by 12 h (see subject 12 in FIG. 1b). Therefore, it is impossible to comprehend the “descent” phase of those compounds and the extrapolation 12-24 h is impossible to do statistically. We therefore considered “truncated” 0-12 h AUC for those subjects knowing that the AUC was incomplete.

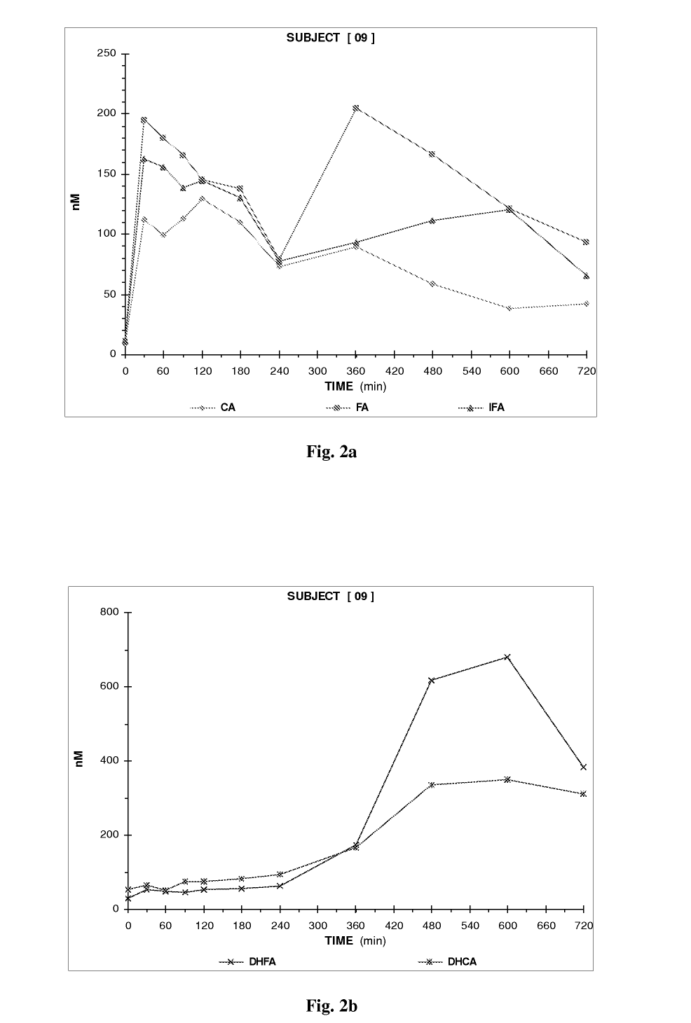

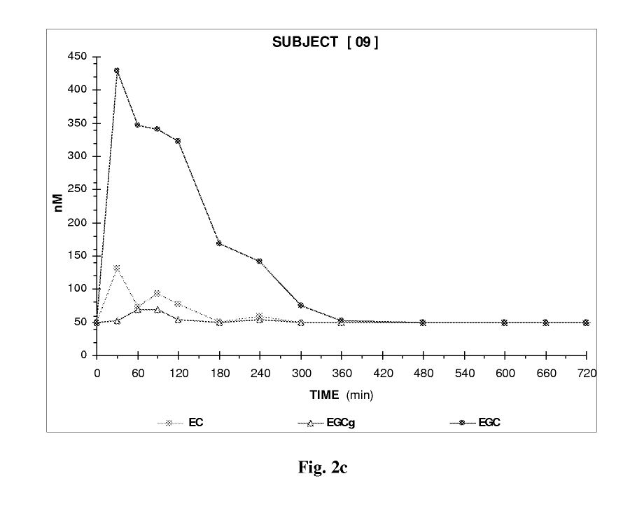

Despite those extreme, some subjects showed “average” plasma kinetic (see subject 09 in FIGS. 2a and 2b), where DHCA and DHFA plasmatic levels were down but not back to baseline by 12 h. Because we had only 1 or 2 points in this descent phase, it was again impossible to extrapolate with accuracy the 12-24 h. Therefore, only the AUC between 0 and 12 h was considered for statistical purposes

Plasma Pharmacokinetics after Ingestion of Green Tea

We detected 3 catechins in plasma after green tea ingestion (EC, EGC and EGCG). All 3 were absorbed very quickly with a Cmax around 1-2 h after ingestion. Clearance from plasma was also rapid to reach baseline level within 6-8 h after ingestion.

We investigated plasma appearance of C, ECG, EC, EGC, EGCG after green tea consumption. However, only EC, EGC, EGCG could be detected in plasma. Below are example of plasma kinetics of those compounds.

As already mentioned, only time points measured between 0 and 12 h were used to calculate AUC.

FIG. 2c shows a typical example of plasma catechins kinetics obtained for subject 09.

Comparison of plasma pharmacokinetics of coffee versus Green tea: summary of PP analysis

The sum of the AUC for coffee was significantly greater than the sum of the AUC for green tea. A conservative approach showed a sum of AUC 1.7 fold greater for coffee compared to green tea. An a posteriori approach by setting all LOQ at 0 gave a factor 2.06.

The comparison was done by summing the area under the curves (AUC₀₋₁₂ₕ) of CA, FA, iFA, DHFA and DHCA for coffee and the area under the curves (AUC₀₋₁₂ₕ) of EC, EGC and EGCg for green tea. Statistical comparison of Tmax or Cmax was not performed as we were investigating a sum of components.

Conservative (Blinded) Analysis:

We first decided to measure AUC with the limit of quantification.

The analysis on the PP data set confirms the results on the ITT data set. The bioavailability of the antioxidants calculated on 12 hours [AUC₍₀₋₁₂₎] is significantly higher in coffee than in Green Tea (mean ratio [95% CI] Coffee/Green Tea=1.72 [1.27, 2.34] p=0.0014).

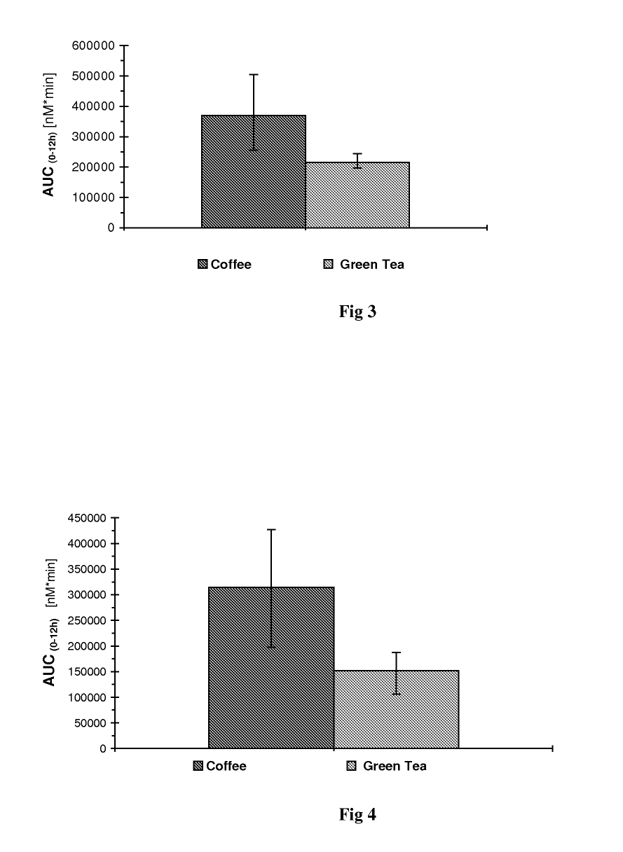

Bioavailability of antioxidants, by treatment group, geometric mean±Q1-Q3, PP data set is shown in FIG. 3.

Treatment effect on antioxidant bioavailability, 95% CI, p-values. PP data set.

| | | CONFIDENCE | | |
|---|---|---|---|---|
| | | INTERVAL | | |
| | | (95%) | | |
| | ESTIMATE | Lower | Upper | PROBABILITY |
| Coffee/Green Tea | 1.7175 | 1.2615 | 2.3388 | 0.0014 |

A Posteriori Analysis

Because LOD=LOQ=50 nM for green tea compounds, the AUC for those metabolites were most likely greater than expected as they are back to baseline (˜0 instead of 50 nM) by 6-8 h after ingestion. It was therefore decided to investigate the same comparison by setting all values below the LOQs for coffee and green tea metabolites at 0 nM. This comparison was done a posteriori:

The analysis on the PP data set confirms the results on the ITT data set. The bioavailability of the antioxidants calculated on 12 hours [AUC₍₀₋₁₂₎] is significantly higher in coffee than in green tea (mean ratio [95% CI] Coffee/Green Tea=2.07 [1.44, 2.98] p=0.0004).

Bioavailability of antioxidants, by treatment group, geometric mean±Q1-Q3, PP data set is shown in FIG. 4.

Treatment effect on antioxidant bioavailability, 95% CI, p-values. PP data set.

| | | CONFIDENCE | | |
|---|---|---|---|---|
| | | INTERVAL | | |
| | | (95%) | | |
| | ESTIMATE | Lower | Upper | PROBABILITY |
| Coffee/Green Tea | 2.0682 | 1.4352 | 2.9806 | 0.0004 |

Comparison of plasma pharmacokinetics of coffee versus coffee 3 in 1 and coffee versus coffee+10% whole milk: summary of PP analysis

Because DHFA and DHCA kinetics were incomplete by 12 h, no statistics were done for those metabolites. AUC of CA, FA and iFA were not significantly different between coffee and coffee+milk, nor for coffee compared to coffee 3 in 1. No difference in Tmax and Cmax were also observed for the addition of milk, while some significant delays in Tmax and reduction of Cmax were observed for coffee 3 in 1.

The comparison between the different coffee treatment (AUC, Tmax and Cmax) was done only for CA, FA and iFA. For colonic metabolites (DHCA and DHFA), most kinetics were incomplete at 12 h after coffee ingestion so that the accurate calculation of Cmax and Tmax was impossible to perform.

Descriptive Data

| | Cₘₐₓ (nM) | | | Tₘₐₓ (min) | | |
|---|---|---|---|---|---|---|
| TREATMENT | [CA] | [FA] | [IFA] | [CA] | [FA] | [IFA] |
| Coffee | 76 | 134 | 93 | 83 | 56 | 50 |
| | [61-90] | [107-178] | [75-113] | [60-120] | [30-60] | [30-60] |
| Coffee with Milk | 64 | 109 | 74 | 62 | 39 | 56 |
| | [47-79] | [92-135] | [63-82] | [30-90] | [30-45] | [30-90] |
| Coffee 3 in 1 | 54 | 103 | 69 | 129 | 181 | 104 |
| | [47-62] | [98-129] | [62-75] | [90-180] | [60-360] | [60-120] |

Geometric Mean (9 Subjects) and [Q1-Q3]

| | AUC_{(0-12 h)} | | |
|---|---|---|---|
| | (nM * min) | | |
| TREATMENT | [CA] | [FA] | [IFA] |
| Coffee | 25303 | 50917 | 31164 |
| | [21272-30321] | [39321-55123] | [22860-36678] |
| Coffee with Milk | 23588 | 44365 | 27567 |
| | [17088-27613] | [37099-50934] | [24819-33551] |
| Coffee 3 in 1 | 21055 | 45033 | 29814 |
| | [16636-23946] | [30824-60219] | [20991-36266] |

Geometric Mean (9 Subjects) and [Q1-Q3]

There is no significant difference on the AUCs between coffee and the other coffee preparations (coffee 3 in 1 and coffee and milk).

AUC₍₀₋₁₂ₕ₎ of antioxidants, by treatment group, geometric mean±Q1-Q3, PP data set shown in FIG. 5.

Treatment effect on AUC₍₀₋₁₂ₕ₎, 95% CI, p-values. PP data set:

| | | | CONFIDENCE | | |
|---|---|---|---|---|---|
| | | | INTERVAL | | |
| | | | (95%) | | |
| | | ESTIMATE | Lower | Upper | PROBABILITY |
| CA | Coffee/ | 1.0727 | 0.7982 | 1.4415 | 0.6215 |
| | Coffee | | | | |
| | with Milk | | | | |
| | Coffee/ | 1.2018 | 0.8943 | 1.6151 | 0.2060 |
| | Coffee | | | | |
| | 3 in 1 | | | | |
| FA | Coffee/ | 1.1477 | 0.8627 | 1.5269 | 0.3215 |
| | Coffee | | | | |
| | with Milk | | | | |
| | Coffee/ | 1.1307 | 0.8499 | 1.5042 | 0.3752 |
| | Coffee | | | | |
| | 3 in 1 | | | | |
| IFA | Coffee/ | 1.1305 | 0.8394 | 1.5223 | 0.3954 |
| | Coffee | | | | |
| | with Milk | | | | |
| | Coffee/ | 1.0453 | 0.7762 | 1.4077 | 0.7565 |
| | Coffee | | | | |
| | 3 in 1 | | | | |

There is no significant difference on the Cmax between coffee and coffee and milk.

Nevertheless, there are some significant differences between the coffee 3 in 1 and coffee particularly on CA (mean ratio [95% CI], 1.41 [1.02, 1.95], p=0.039) and IFA (mean ratio [95% CI], 1.34 [1.04, 1.76], p=0.027), to a lower extent on FA (mean ratio [95% CI], 1.30 [0.96, 1.76], p=0.08). On all these molecules, the Cmax tends to be lower in the coffee 3 in 1 than in the coffee treatment group.

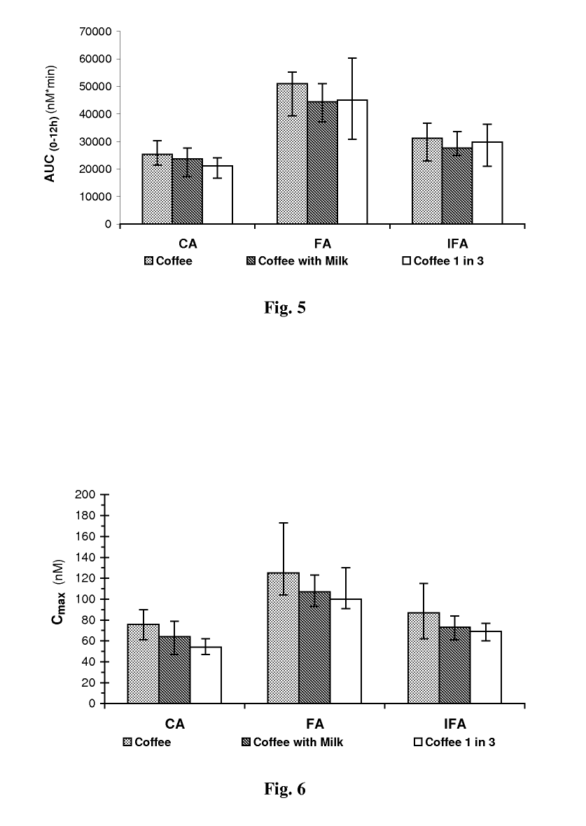

Cmax of antioxidants, by treatment group, geometric mean±Q1-Q3, PP data set shown in FIG. 6.

Treatment effect on Cₘₐₓ, 95% CI, p-values. PP data set:

| | | | CONFIDENCE | | |
|---|---|---|---|---|---|
| | | | INTERVAL | | |
| | | | (95%) | | |
| | | ESTIMATE | Lower | Upper | PROBABILITY |
| CA | Coffee/ | 1.1784 | 0.8500 | 1.6218 | 0.3026 |
| | Coffee | | | | |
| | with Milk | | | | |
| | Coffee/ | 1.4142 | 1.0200 | 1.9498 | 0.0390 |
| | Coffee | | | | |
| | 3 in 1 | | | | |
| FA | Coffee/ | 1.2219 | 0.9053 | 1.6493 | 0.1806 |
| | Coffee | | | | |
| | with Milk | | | | |
| | Coffee/ | 1.3002 | 0.9633 | 1.7551 | 0.0834 |
| | Coffee | | | | |
| | 3 in 1 | | | | |
| IFA | Coffee/ | 1.2549 | 0.9641 | 1.6334 | 0.0882 |
| | Coffee | | | | |
| | with Milk | | | | |
| | Coffee/ | 1.3505 | 1.0375 | 1.7579 | 0.0272 |
| | Coffee | | | | |
| | 3 in 1 | | | | |

There is no significant difference on the Tmax between coffee and coffee with milk.

Nevertheless, there are significant differences between the coffee 3 in 1 and coffee particularly on FA (mean ratio [95% CI], 0.31 [0.14, 0.72], p=0.009) and IFA (mean ratio [95% CI], 0.84 [0.73, 0.96], p=0.015), and, to a lower extent on CA (mean ratio [95% CI], 0.64 [0.40, 1.03], p=0.062).

On all these molecules, the Tmax is higher in the coffee 3 in 1 than in the coffee treatment group.

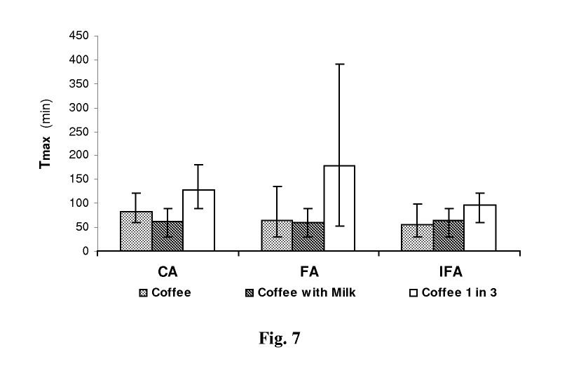

Tmax of antioxidants, by treatment group, geometric mean±Q1-Q3, PP data set shown in FIG. 7.

Treatment effect on Tₘₐₓ, 95% CI, p-values. PP data set:

| | | | CONFIDENCE | | |
|---|---|---|---|---|---|
| | | | INTERVAL | | |
| | | | (95%) | | |
| | | ESTIMATE | Lower | Upper | PROBABILITY |
| CA | Coffee/ | 1.3431 | 0.8408 | 2.1454 | 0.2006 |
| | Coffee | | | | |
| | with Milk | | | | |
| | Coffee/ | 0.6419 | 0.4019 | 1.0255 | 0.0621 |
| | Coffee | | | | |
| | 3 in 1 | | | | |
| FA | Coffee/ | 1.4233 | 0.5999 | 3.3760 | 0.3988 |
| | Coffee | | | | |
| | with Milk | | | | |
| | Coffee/ | 0.3109 | 0.1350 | 0.7160 | 0.0092 |
| | Coffee | | | | |
| | 3 in 1 | | | | |
| IFA | Coffee/ | 0.9584 | 0.8341 | 1.1013 | 0.5261 |
| | Coffee | | | | |
| | with Milk | | | | |
| | Coffee/ | 0.8360 | 0.7276 | 0.9606 | 0.0147 |
| | Coffee | | | | |
| | 3 in 1 | | | | |

The present study has identified the presence of FA and iFA that follow similar kinetics than CA (maximum plasma appearance 1-2 h after ingestion). Therefore, those metabolites are more likely to be absorbed at the level of the small intestine and metabolized by the small intestine or the liver. We did not detect 5-CQA or any other parent compounds because we used a full enzymatic cleavage method. This included the use of an esterase that cleaved all possible CQA, FQA or di-CQA present in plasma to release only CA and FA. Therefore, we detected CA, FA and iFA but the hypothesis that parent compounds may be absorbed as such cannot be excluded from the data we obtained.

A major finding in the present study is the detection of colonic metabolites, namely DHFA and DHCA in significant concentration (Cmax>1•mol in some subjects for DHFA). However, we failed to obtain complete kinetics of those metabolites for most subjects as after 12 h after ingestion, Tmax was still not reached for some subjects or was not back to baseline for others. To our knowledge, only one other report showed the presence of DHCA and DHFA in plasma after CGA consumption from artichoke leaf extract (Wittemer et al. 2005). The authors also found significant amounts of DHCA appearing in plasma and both colonic metabolites showed a late Tmax at about 6 h. In the present study, Tmax for DHFA and DHCA was estimated ˜10 h after ingestion, much later than what has been reported by Wittemer et al. Thus, the matrix and form of delivery of the chlorogenic acids modulates pharmacokinetics parameters (especially Tmax). Ingestion of chlorogenic acids with food (breakfast given with beverage in the present study) or without (Wittemer et al.) may also contribute in explaining those differences. Indeed, adding a food source may interfere with gastric emptying and gut transit time so that Tmax may be significantly shorter or longer, depending on the food source.

We believe, our study is also the first to investigate plasma kinetics of phenolics from coffee over 12 h after ingestion and the first to demonstrate the biphasic phenomenon observed with plasma kinetics of coffee metabolites. Some metabolites (CA, FA and iFA) have an early Cmax at ˜1-2 h while colonic metabolites (DHFA and DHCA) peaked at 10-12 h after ingestion. This clearly suggests that part of coffee bioactive is metabolized by the small intestine, hence the early appearance of CA, FA and iFA. The other part is metabolized by the colon to produced the later peaks from DHFA and DHCA. The importance of the colon in producing metabolites is a new piece of information and should be considered as key whenever studying bioavailability of chlorogenic acids.

The study showed that EGC is the major metabolite appearing in plasma and that EGCG is not as well absorbed compared to the ingested dose (EGCG is the most prevalent catechin source in green tea sources). In the present study, Cmax of EGC peaked at ˜500 nM while EGCG peaked at ˜80 nM, which is also in agreement with the published literature. Variability in AUC, Tmax and Cmax observed throughout those studies may be dependant on the population studied, the dose and source of green tea.

There has been reports of the presence of other methyl metabolites from green tea present in plasma after absorption and that are not cleaved by regular •-glucuronidase+sulfatase, namely 4′,4″-DiMeEGCg and 4′-O-Me-EGC. Despite the fact that those methyl catechins were not considered in the metabolites measured for comparison with coffee metabolites, we still investigated if 4′-O-Me-EGC was present in our plasma samples. We chemically synthesized the methyl standard and set up MS parameters to further detect this metabolite in plasma samples extracted from the current study. Plasma analysis of 2 of the subjects showed that 4′-O-Me-EGC was not detected in any samples. Therefore, methyl catechins may be considered as minor metabolites.

To our knowledge, this is the first study that is investigating the comparison of bioavailability of antioxidants from coffee and green tea. We decided to focus on what we thought were the major metabolites from coffee and green tea. The method for plasma analysis after drinking coffee included an enzymatic cleavage with B-glucuronidase, sulfatase and esterase to release all metabolites as CA, FA, iFA and DHFA and DHCA. With this method, all possible CQA, diCQA and FQA that might have been absorbed and present in plasma have been cleaved to release CA (from CQA and di-CQA) and FA (FQA). We also investigated DHFA and DHCA as we thought those could be major metabolites produced by the microflora.

The comparison of the sum of the AUC for CA, FA, iFA, DHFA and DHCA for coffee to the sum of EC, EGC and EGCG for tea (C and ECG not detected) seem to provide a solid basis for comparison of the bioavailability of the 2 beverages. In this particular setting, statistical analysis showed that coffee was 1.7 fold more bioavailable than green tea using a conservative approach with the replacement of values below the LOQ values set. A posteriori approach that set all values below the LOQs at 0 provided us with the same significance of coffee being more bioavailable than green tea. The factor for this comparison was 2.06 fold.

Comparison Between Coffee Treatments

Statistical analyses of secondary objectives were done on AUC, Cmax and Tmax of CA, FA and iFA for coffee vs. coffee 3 in 1 and for coffee vs. coffee+milk. No secondary statistics were done on AUC, Cmax and Tmax of DHCA and DHFA as most subjects showed kinetics that were not back to baseline 12 h after ingestion. Therefore, calculations of Tmax and Cmax were impossible to perform.

Comparison of coffee and coffee with 10% whole milk showed that both treatments were not significantly different from each other for AUC, Cmax and Tmax of CA, FA and iFA. The possible effect of milk on metabolism and absorption of colonic metabolites DHCA and DHFA still remain to be fully investigated as incomplete kinetics did not allow us to draw any conclusion on this aspect of the study. To our knowledge, this study is the first to investigate the effect of milk on the human plasma bioavailability of CGA metabolites.

Comparison of coffee with coffee 3 in 1 allowed us to investigate the effect of addition of non dairy creamer and sugar to coffee. Statistical analysis of secondary objectives showed that although the AUC of CA, FA and iFA were not significantly different between both treatments, some differences in Cmax and Tmax were observed. Indeed, Cmax of CA and iFA were significantly lower and Tmax of FA and iFA significantly longer for the coffee 3 in 1 group compared to coffee. Therefore, we may hypothesize that although the delivery of CGA metabolites is not significantly different between both treatments, the addition of non dairy creamer and sugar to coffee may lead to significant changes in the aspect of plasma kinetics of those metabolites. The effect on colonic metabolites by obtaining full kinetics remain to be further investigated. This would give us stronger knowledge to pursue in greater details how bioavailability relates to bioefficacy.

In conclusion, the present study showed that addition of milk and non dairy creamer was not statistically different from black coffee.

This study conformed the presence of caffeic acid and obtained fuller kinetics than any other referenced study; identified the presence of FA and iFA appearing within 1-2 h after ingestion and the presence of DHCA and DHFA appearing 8-12 h after ingestion; and shows the biphasic absorption phenomenon, underlying the importance of both the small intestine and the colon for metabolizing and absorbing coffee metabolites.

Because coffee and green tea are two widely consumed beverages, the present study led us to investigate plasma pharcokinetics of phenolic acids and catechins after drinking coffee and green tea, respectively. Our data showed that coffee is more bioavailable than green tea by a factor 1.7 (conservative) or 2.06 (a posteriori) on a basis of 2 Australian servings for each beverage. This was showed by comparing the sum of the area under the curve of coffee metabolites to those from green tea.

We also investigated the effect of milk or non dairy creamer on coffee chlorogenic acid absorption. Our data showed that for intestinal metabolites (CA, FA and iFA), there was no significant effect of milk or non dairy creamer on absorption of coffee bioactive. The possible effect on bioavailability of colonic metabolites remains to be further investigated.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for selling a coffee product comprising the steps of advertising that the coffee product provides to a consumer more bioavailable antioxidants than green tea based on the ingestion of the same quantities of green tea and coffee.

2. The method of claim 1 wherein the advertising is made by a method selected from the group of media consisting of in print, on television, on the radio, and on the interne.

3. The method of claim 1 comprising the step of advertising that milk can be added to the coffee product.

4. The method of claim 1 comprising the step of advertising the benefits of antioxidants to the consumer.

5. The method of claim 1 wherein the advertising is on a label of a container housing the product.

6. The method of claim 1 wherein the advertising steps comprises the use of a product label.

7. A method for promoting the benefits of a coffee product comprising the step of stating that coffee in the coffee product provides more bioavailable polyphenols to a consumer when ingested than a similar quantity of green tea.

8. The method of claim 7 comprising the step of highlighting the benefits of polyphenols to the consumer.

9. The method of claim 7 wherein the stating is made by a method selected from the group of media consisting of in print, on television, on the radio, and on the internet.

10. A method for promoting a consumable product comprising the steps of:
noting that the consumable product contains coffee; and
stating that coffee provides a consumer of the consumable product more bioavailable antioxidants than a similar quantity of green tea.

11. The method of claim 10 wherein the noting and stating steps comprise the use of a product label.

12. The method of claim 10 wherein the noting and stating steps comprise the use of the internet.

13. The method of claim 10 wherein the consumable product is selected from the group consisting of a drink, a chewable food product, pet food, and a nutritional supplement.

14. The method of claim 10 comprising the step of touting the benefits of antioxidants to the consumer.

15. The method of claim 10 comprising the step of making available to the consumer test data comprising the bioavailability of antioxidants in coffee to green tea.

16. A package comprising a coffee containing product and a label that comprises a statement that the coffee provides more bioavailable antioxidants to a consumer than a similar quantity of green tea.

17. The package of claim 16 wherein the coffee product is selected from the group consisting of a drink, a food, and a nutritional supplement.

18. The package of claim 16 wherein the package comprises a plurality of single serving sizes.

19. The package of claim 16 wherein the coffee containing product is designed to provide a hot beverage.

20. The package of claim 16 wherein the label states that milk can be added to the product.

21. The package of claim 16 wherein the label includes information assisting the consumer in accessing comparative testing between coffee and green tea.

22. An advertising campaign based on utilizing data demonstrating that coffee provides a consumer with more bioavailable antioxidants than green tea per consumption of similar quantities.

23. The campaign of claim 22 wherein the data is based on plasma pharmacokinetics.

24. The campaign of claim 22 wherein the data is based on bioavailability of polyphenols.

25. The campaign of claim 22 comprising the step of promoting a product that provides a hot coffee beverage.

26. The campaign of claim 22 comprising the step of promoting a product selected from the group consisting of a food, a drink, and a nutritional supplement.

27. The campaign of claim 22 comprising the step of using at least one media selected from the group consisting of television, interne, print, and radio.
